(19) United States
(12) Patent Application Publication
(10) Pub. No.: US 2012/0242925 A1
(43) Pub. Date: Sep. 27, 2012

(54) Liquid Crystal Display Device

(76) Inventor: Saburo WATANABE, Ichinomiya (JP)

(21) Appl. No.: 13/415,620

(22) Filed: Mar. 8, 2012

(30) Foreign Application Priority Data
Mar. 22, 2011 (JP) 2011-063330

(51) Int. Cl. G02F 1/13357

(52) U.S. Cl. 349/58

(57) ABSTRACT

An object of the present invention is to prevent degradation of image contrast arising from deformation of a liquid crystal display panel caused by deformation of the upper surface of the middle frame on which the liquid crystal display panel is mounted.

A liquid crystal display panel is disposed on the upper surface of a middle frame with cushion tape. The middle frame has its upper surface folded back to form a double-layer structure to enhance the strength. Its side surfaces are of a single-layer structure. As the upper surface of the middle frame is planarized and its strength is enhanced, deformation of the liquid crystal display panel can be prevented. This in turn prevents occurrence of optical leakage during black display, thereby preventing the contrast from being degraded.

### CLAIM OF PRIORITY

The present application claims priority from Japanese Patent Application JP 2011-063330 filed on Mar. 22, 2011, the content of which is hereby incorporated by reference into this application.

### BACKGROUND OF THE INVENTION

1. Field of the Invention

The present invention generally relates to liquid crystal display devices, and particularly to a liquid crystal display device adapted to stave off display unevenness arising from distortion of its liquid crystal display panel caused by deformation of the frame accommodating the liquid crystal display panel.

2. Description of Related Art

A display area of liquid crystal display devices is formed from a TFT substrate having pixel electrodes, thin film transistors (TFT), etc. formed in a matrix; a counter substrate opposing the TFT substrate and having color filters, etc. formed at positions corresponding to the pixel electrodes of the TFT substrate; and liquid crystals put between the TFT substrate and the counter substrate. Images are formed by controlling the light transmittance of liquid crystal molecules of each pixel.

Liquid crystal display devices include a housing composed of an upper frame, a middle frame or a resin mold, a lower frame, etc., and within the housing, components constituting a liquid crystal display panel and backlight such as a light source, a light guide plate, an optical sheet, etc. Liquid crystal display panels have a nature such that display unevenness occurs when they are distorted by stress. For this reason, liquid crystal display panels are typically simply rested on the middle frame or resin mold so that no stress is applied thereto. Meanwhile, for manufacturing requirement, or when the liquid crystal display device is to be subjected to vibration or the like, the liquid crystal display panel is affixed to the mold or the middle frame with cushion tape having adhesives thereon to thereby restrain movement of the liquid crystal display panel.

JP-A-2008-158432 discloses a configuration in which a flexible resin mold is used to accommodate a liquid crystal display panel in order to limit inclination of the resin mold and outer frame. In this case, the liquid crystal display panel is affixed to the resin mold with an adhesive tape so that the positional relation of the liquid crystal display panel and resin mold would not deviate when the resin mold accommodating the liquid crystal display panel is inserted into the outer frame.

### SUMMARY OF THE INVENTION

Lately, application of liquid crystal display devices to displays of a speedometer, fuel gauge, and the like in automotive dashboards is increasing. Liquid crystal display devices mounted on vehicles are subjected to vibration, impact, etc., which makes the liquid crystal display panel liable to move. In view of this, cushion tape having adhesives thereon is disposed between the liquid crystal display panel and the resin mold or the middle frame, on which the liquid crystal display panel is mounted, so as to restrain movement of the liquid crystal display panel.

FIG. 5 is a cross-sectional view of a liquid crystal display device including the structure of the invention. The upper surface of the middle frame 3 is folded back against itself, which is a structure of the present invention. The upper surface of the conventional middle frame is not folded but only one board.

A liquid crystal display panel 2 is placed between an upper frame 1 and lower frame 9. In FIG. 5, the liquid crystal display panel 2 is mounted on a middle frame 3 formed of SUS or other metal instead of a resin mold. Cushion tape 4 is interposed between the middle frame 3 and the liquid crystal display panel 2 to fix the liquid crystal display panel 2 in place. As shown in FIG. 7, the cushion tape 4 is formed from a cushion material 41 and adhesives 42 formed on both sides.

The liquid crystal display panel 2 includes a TFT substrate 21 having TFTs, pixel electrodes, etc. formed in a matrix and a counter substrate 22 having color filters etc. formed thereon. The TFT substrate 21 is formed to be larger in size than the counter substrate 22. The part of the TFT substrate 21 where the counter substrate 22 does not overlap serves as a terminal section. A flexible wiring substrate 10 for the liquid crystal display panel is attached to the terminal section.

A backlight is disposed inside the middle frame 3. The backlight includes an LED 6 disposed along a side of a light guide plate 5 as a light source, an LED flexible wiring substrate 7, etc. A reflective sheet 11 is disposed beneath the light guide plate 5. An optical sheet group 8, including sheets such as a diffusion sheet and prism sheet, is disposed on the light guide plate 5.

The liquid crystal display panel 2 is bonded onto the middle frame 3 via the cushion tape 4. The middle frame 3 is formed by pressing metal such as SUS. The middle frame 3 is as thin as about 0.3 mm, and it is very often distorted already in fabrication. FIG. 6 shows a typical case of this distortion. In FIG. 6, the upper surface of the middle frame 3 to which the liquid crystal display panel 2 is to be bonded via the cushion tape 4 is distorted. The middle frame of FIG. 6 does not have the folded structure at the upper surface but one board structure as depicted at FIG. 8.

The liquid crystal display panel 2 has a plate-like form and its thickness is small relative to its outline. Therefore, as the liquid crystal display panel 2 is affixed to the middle frame 3 via the cushion tape 4, it is easily deformed along the distortion of the upper surface of the middle frame 3. The deformation of the liquid crystal display panel 2 changes the optical path in the liquid crystal layer. This causes optical leakage, resulting in a reduced contrast.

To prevent such deformation of the middle frame 3, one possible solution is to enhance the mechanical strength of the middle frame 3 by increasing its thickness. However, if the plate thickness of the middle frame 3 is doubled, its weight will be doubled, and also the material cost for the middle frame 3 will increase. In addition, assembling of the middle frame 3 with the lower frame 9 or the upper frame 1 would become difficult.

That is, for example, referring to FIG. 8, the middle frame 3 and the lower frame 9 are assembled together by a method called snap fitting 20. FIG. 8 is a cross-sectional view showing a state where the middle frame 3 and the lower frame 9 are assembled together by snap fitting 20. A hole is formed in the lower frame 9, into which the bent portion of a side of the middle frame 3 is fitted to connect the middle frame 3 and the lower frame 9.

Referring to FIG. 8, if the thickness of the material of the middle frame 3 is increased, the bent portion would be difficult to form. Hence the assembly of the middle frame 3 and the lower frame 9 by snap fitting 20 becomes difficult to accomplish, another assembly method needs to be adopted. Snap fitting 20 is advantageous in terms of cost, so adopting another assembly method is disadvantageous in terms of manufacturing cost. The same can be said for the assembly of the middle frame 3 and upper frame 1.

An object of the present invention is to provide a liquid crystal display device of which liquid crystal display panel 2 is prevented from being deformed so that optical leakage particularly during black display is staved off to offer good contrast without a significant manufacturing cost increase.

The present invention was devised to overcome the above problems. One aspect of the present invention is a liquid crystal display device comprising:

an upper frame;

a middle frame formed of metal; and

a liquid crystal display panel disposed between the upper frame and the middle frame; wherein:

the middle frame has an upper surface being folded back against itself to form a double-layer structure and side surfaces of a single-layer structure;

the liquid crystal display panel is mounted on the middle frame; and

a backlight is disposed inside the middle frame.

Alternatively, the liquid crystal display panel may be fixed in place by clamping it with the upper frame and the middle frame. The liquid crystal display panel may as well be fixed to the upper surface of the middle frame via cushion tape, and the upper frame may be disposed thereover to cover it.

According to the present invention, the upper surface of the middle frame, on which the liquid crystal display panel is placed, can be planarized. This prevents occurrence of optical leakage arising from deformation of a liquid crystal display panel, whereby a liquid crystal display device with good contrast can be achieved. In addition, a middle frame with a flat upper surface can be made without increasing its overall plate thickness, which allows a liquid crystal display device with good contrast to be achieved without significantly increasing the cost.

Further, the part of the middle frame on which the liquid crystal display panel is rested can have practically enhanced mechanical strength. The liquid crystal display panel can therefore be prevented from being deformed by a stress applied thereon upon assembly of the liquid crystal display device to its body device. Thus, the contrast of the screen would not be degraded upon assembly of the liquid crystal display device to its body device.

### BRIEF DESCRIPTION OF THE DRAWINGS

The present invention will be described hereinafter with reference to the accompanying drawings.

FIG. 1 is a cross-sectional view showing a liquid crystal display device according to a first embodiment of the present invention.

FIG. 2 is an exploded perspective view showing the liquid crystal display device according to the first embodiment of the present invention.

FIG. 3 is an illustration showing a manufacturing process of a middle frame.

FIG. 4 is a cross-sectional view showing a liquid crystal display device according to a second embodiment of the present invention.

FIG. 5 is a cross-sectional view showing a liquid crystal display device including the present invention.

FIG. 6 is a perspective view showing a problem of the middle frame in the liquid crystal display device of the conventional example.

FIG. 7 is a cross-sectional view showing a cushion tape.

FIG. 8 is a cross-sectional view showing a concept of snap fitting.

### DETAILED DESCRIPTION OF THE PREFERRED EMBODIMENTS

Preferred embodiments of the present invention will be described in details below.

### First Embodiment

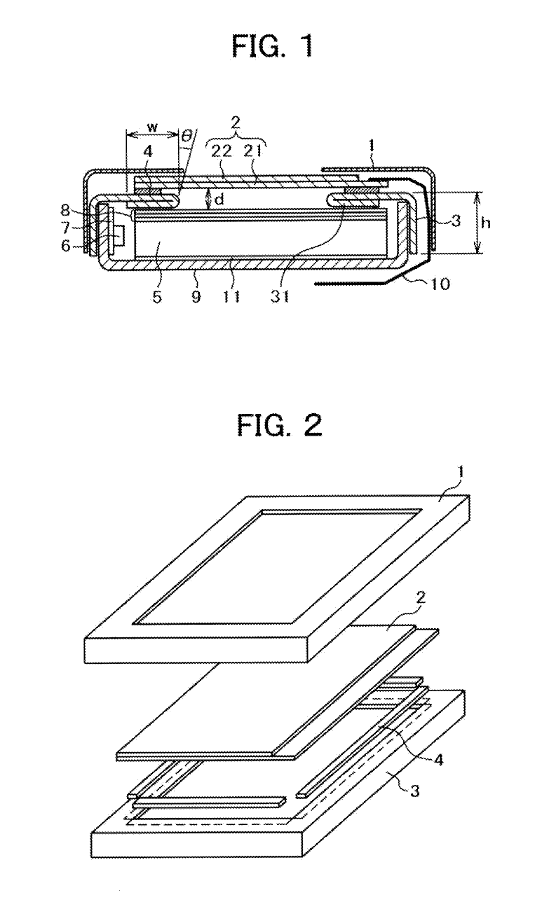

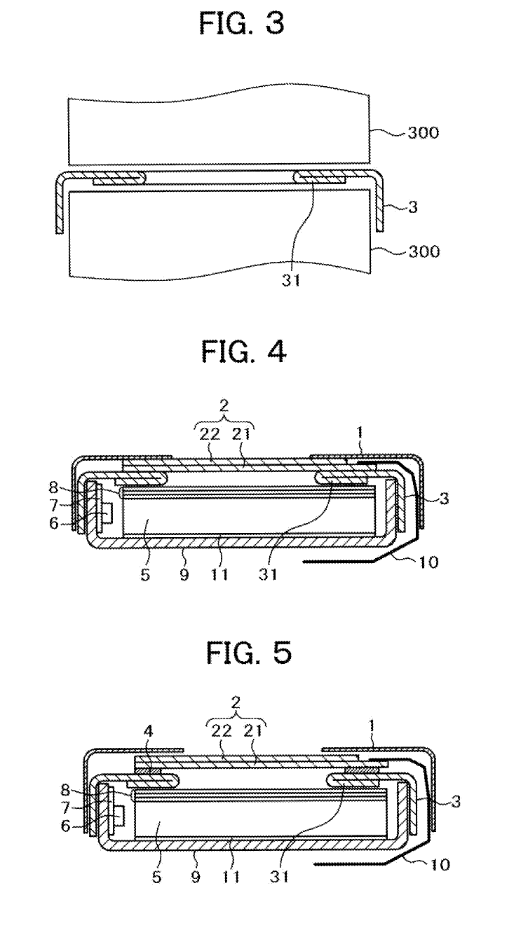

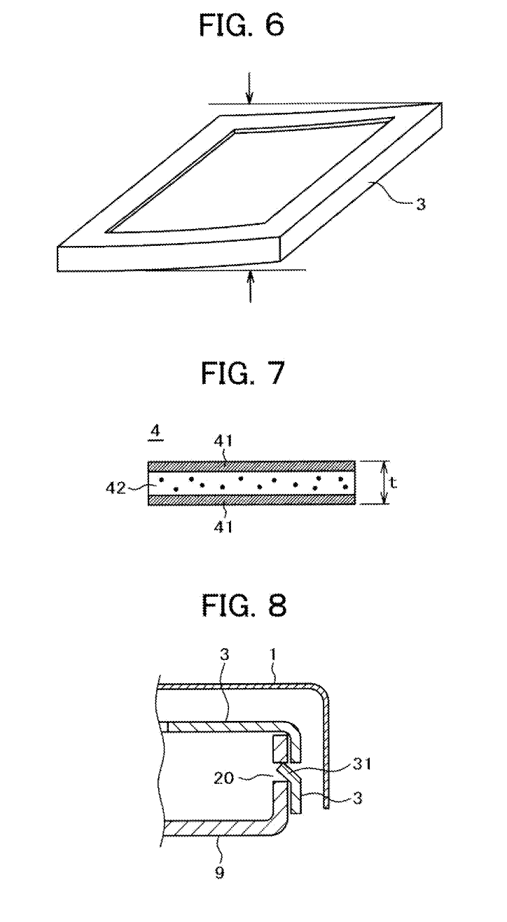

FIG. 1 is a cross-sectional view showing a liquid crystal display device according to a first embodiment of the present invention. The liquid crystal display device of the first embodiment is basically configured similarly to the device described in FIG. 5. Referring to FIG. 1, an upper frame 1 covers the peripheral area of a liquid crystal display panel 2. The liquid crystal display panel 2 is fixed to a middle frame 3 with cushion tape 4. The peripheral area of the liquid crystal display panel 2 exists between the cushion tape 4 and the upper frame 1. The point where the liquid crystal display device shown in FIG. 1 greatly differs from the conventional one shown at FIG. 8 are the structure of the middle frame 3. In FIG. 1, the upper surface of the middle frame 3 is folded back against itself. The upper surface of the middle frame 3 can thus have an enhanced mechanical strength in the present invention. In addition, after being formed by pressing, the middle frame 3 is pressed by press dies 300 from above and below to improve flatness.

While the plate thickness of the middle frame 3 is about 0.3 mm, the thickness of its upper surface, where the flatness is important, is about 0.6 mm thick. Bending strength of a plate is proportional to the cube of the plate thickness. Thus, the upper surface of the middle frame 3 in the liquid crystal display device of the first embodiment is eight times as strong as that of the conventional devices. At least the upper surface of the middle frame 3 is very unlikely to deform even if an external force is applied to the middle frame 3 after press forming. Further, even if a finished liquid crystal display device is subjected to stress during its assembly to another device, the liquid crystal display panel 2 is unlikely to be deformed thanks to the strengthened upper portion of the middle frame 3. The image contrast of the liquid crystal display device can be prevented from being degraded by deformation of the liquid crystal display panel 2.

Referring to FIG. 1, the cushion tape 4 has a thickness of 1 mm and the plate thickness of the middle frame 3 is 0.3 mm. Since the upper surface of the middle frame 3 is folded back, the distance “d” between an optical sheet group 8 and the lower surface of the liquid crystal display panel 2 is increased by 0.3 mm for the plate thickness of the middle frame 3, which makes the distance “d” about 1.6 mm. However, the distance “d” had originally been about 1.3 mm, so there is little effect on the diameter of the display area when viewed obliquely, for example, at θ degrees as shown in FIG. 1. Further, although the thickness of the entire liquid crystal display device increases by about 0.3 mm by folding back the middle frame 3, the height h of the middle frame 3 is about 5 mm as shown in FIG. 1. There would be no large effect on the thickness of the entire liquid crystal display device either.

Preferably, a fold-back portion 31 of the upper surface of the middle frame 3 has a width w of 3 mm or more. This is because the width of the overlap between the liquid crystal display panel 2 and the middle frame 3 is often about 3 mm. In FIG. 1, the upper frame 1 is formed of SUS and has a plate thickness of about 0.3 mm. A lower frame 9 is formed of Al and has a plate thickness of about 1 to 2 mm. As the lower frame 9 also has a function of heat dissipation, it is formed thick and from Al which has good thermal conductivity.

A light guide plate 5 has a thickness of about 3 mm. An LED 6 is disposed along a side face of the light guide plate 5. The gap between the side face of the light guide plate 5 and the LED 6 is about 0.3 mm. The gap is provided allowing for thermal expansion of the light guide plate 5.

FIG. 2 is an exploded perspective view showing components of the device from the upper frame 1 to the middle frame 3. Referring to FIG. 2, the liquid crystal display panel 2 is mounted on, via the cushion tape 4, the middle frame 3 whose upper portion is folded back to improve flatness. A cross section of the cushion tape 4 is as shown in FIG. 7. The cushion tape 4 has a thickness of about 1 mm and a width of about 1 to 3 mm.

After mounting the liquid crystal display panel 2 on the upper surface of the middle frame 3 as described above, the upper frame 1 is attached. The upper frame 1 and the middle frame 3 are connected together by snap fitting 20 as shown in FIG. 8. Both the upper frame 1 and the middle frame 3 have side faces as thin as about 0.3 mm so that snap fitting 20 can be adopted. The liquid crystal display panel 2 is not held by the upper frame 1 and do not contact therewith. The liquid crystal display panel 2 therefore receives no stress from the upper frame 1.

In FIGS. 1 and 2, an In Plane Switching (IPS) type is used for the liquid crystal display panel 2. IPS liquid crystal display panels 2 have an excellent view angle characteristic. However, IPS liquid crystal display panels 2 are greatly affected by optical leakage caused by deformation. If the present invention is applied to IPS liquid crystal display devices, therefore, great advantageous effect can be obtained.

### Second Embodiment

The liquid crystal display device of the first embodiment is such that the liquid crystal display panel 2 is fixed to the upper portion of the middle frame 3 with the cushion tape 4. Meanwhile, a device to which the present invention is applicable is not limited to the type in which the liquid crystal display panel 2 is fixed with the cushion tape 4. It can be also applied to a type in which the liquid crystal display panel 2 is fixed in place by being clamped with the middle frame 3 and the upper frame 1.

FIG. 4 is a cross-sectional view showing a liquid crystal display device according to a second embodiment of the present invention. Referring to FIG. 4, a TFT substrate 21 of a liquid crystal display panel 2 is directly disposed on a middle frame 3 without cushion tape 4. An upper frame 1 directly presses down a counter substrate 22 of the liquid crystal display panel 2. The liquid crystal display panel 2 is fixed in place by being clamped with the upper frame 1 and the middle frame 3.

The upper frame 1 is not especially processed to improve flatness and is similar to that of the conventional devices. The middle frame 3 has an upper portion folded back against itself and the upper portion is also processed to improve flatness. As the upper surface of the middle frame 3 is flat, even if the inner side of the upper frame 1 is uneven, the liquid crystal display panel 2 would not be distorted. This prevents occurrence of optical leakage in the liquid crystal display panel 2.

The foregoing description assumes that the liquid crystal display panel 2 contacts directly with the upper frame 1 or the middle frame 3 formed of metal. If the TFT substrate 21 or the counter substrate 22 is formed of glass, and the glass is possible to crack by contact with metal, a cushion such as light-blocking tape of about 0.1 to 0.3 mm may be affixed between the liquid crystal display panel 2 and the upper frame 1 or the middle frame 3.

In the second embodiment, thick cushion tape 4 such as the one used in the first embodiment is not used. This eliminates the problems caused by folding back the middle frame 3, that is, problems concerning the effective diameter of the display area and the overall thickness of the liquid crystal display device. In this embodiment described above, the liquid crystal display panel 2 is fixed in place by clamping its peripheral part with the middle frame 3 and the upper frame 1. Alternatively, stopper-like element may be formed on the upper surface of the middle frame 3 or other places, in which the liquid crystal display panel 2 is accommodated within a predetermined area. The liquid crystal display panel 2 can then be restricted from moving horizontally without being clamped by the upper frame 1 and the middle frame 3. In this case as well, hence the upper surface of the middle frame 3 is flat, the liquid crystal display panel 2 can be prevented from being deformed along a deformed upper surface of a middle frame 3, particularly when the liquid crystal display panel 2 is large in size. This embodiment offers strong advantageous effect especially when it is applied to IPS liquid crystal display devices as with the first embodiment.

What is claimed is:

1. A liquid crystal display device comprising:
an upper frame;
a middle frame formed of metal; and
a liquid crystal display panel disposed between the upper frame and the middle frame; wherein:
the middle frame has an upper surface being folded back against itself to form a double-layer structure and side surfaces of a single-layer structure;
the liquid crystal display panel is mounted on the middle frame; and
a backlight is disposed inside the middle frame.

2. The liquid crystal display device according to claim 1, wherein:
the middle frame and the upper frame are connected together by snap fitting.

3. A liquid crystal display device comprising:
an upper frame;
a middle frame formed of metal; and
a liquid crystal display panel disposed between the upper frame and the middle frame; wherein:
the middle frame has an upper surface being folded back against itself to form a double-layer structure and side surfaces of a single-layer structure;
the liquid crystal display panel is mounted on the middle frame and fixed in place by being clamped with the middle frame and the upper frame; and
a backlight is disposed inside the middle frame.

4. The liquid crystal display device according to claim 3, wherein:
the middle frame and the upper frame are connected together by snap fitting.

5. A liquid crystal display device comprising:
an upper frame;
a middle frame formed of metal; and
a liquid crystal display panel disposed between the upper frame and the middle frame; wherein:
the middle frame has an upper surface being folded back against itself to form a double-layer structure and side surfaces of a single-layer structure;
the liquid crystal display panel is fixed to the middle frame with cushion tape; and
a backlight is disposed inside the middle frame.

6. The liquid crystal display device according to claim 5, wherein:
the middle frame and the upper frame are connected together by snap fitting.

7. The liquid crystal display device according to claim 1, wherein:
the liquid crystal display panel is an IPS type.

8. The liquid crystal display device according to claim 3, wherein:
the liquid crystal display panel is an IPS type.

9. The liquid crystal display device according to claim 5, wherein:
the liquid crystal display panel is an IPS type.
